(19) United States
(12) Patent Application Publication
(10) Pub. No.: US 2009/0105683 A1
(43) Pub. Date: Apr. 23, 2009

(54) Disposable Injection-Molded Container for Biologic Fluids and Method of Manufacture

(75) Inventors: Jeffrey Lee SPRAY, Erie, CO (US); Kristina HERMANN, Arvada, CO (US); Barry Lynn BENNETT, Arvada, CO (US); Andrew JOHNSTON, Westminster, CO (US)

Correspondence Address: CaridianBCT, Inc.;Mail Stop: 810 1F2, 10811 WEST COLLINS AVE, LAKEWOOD, CO, 80215, US

(73) Assignee: CARIDIANBCT, INC., Lakewood, CO (US)

(21) Appl. No.: 12/237,494

(22) Filed: Sep. 25, 2008

Related U.S. Application Data
(60) Provisional application No. 60/980,971, filed on Oct. 18, 2007.

(51) Int. Cl. A61J 1/05

(52) U.S. Cl. 604/403; 264/240

(57) ABSTRACT

A disposable container for biologic materials comprising a sheet of flexible material with an access area integrally molded in the sheet. At least one port in the access area passes fluid into the container. The sheet is folded along the access area such that an upper part is adjacent a lower part, and the upper part is attached to the lower part. The method for making the container includes forming a sheet having an access area integrally molded in the sheet, folding the sheet along the access area, and joining the upper part to the lower part. The upper and lower sheets and the access area are injection-molded as a single, unitary piece. This process uses a mold having a central triangular prism and conforming upper and lower blocks.

### FIELD OF THE INVENTION

The present invention relates to containers or bags for biologic fluids, particularly blood processing disposable bags, and to methods for making such bags or containers.

### DESCRIPTION OF THE RELATED ART

Flexible, biologically compatible bags are commonly used in the medical industry to receive fluids of various types, particularly in connection with treatment of patients and in connection with acquiring or processing biologic fluids. For example, bags may be used to deliver solutions, such as normal saline solution, or medications to a patient, often intravenously. Similarly, blood or other fluids may be collected from a patient or donor in biologically compatible bags. Blood, for example, may be collected and processed at a later time, or it may be processed immediately and certain components may be returned to the donor or patient. A disposable, sterile set of bags or containers is often used in connection with a centrifuge for separation of such components.

The use of multiple bags may become costly as the user would have to purchase more bags to accommodate higher volumes as well as pay associated disposal costs for buffer and waste bags. Bio-compatible bags are often made by molding an access part out of a comparatively rigid polymer, the part having one or more access ports whereby tubes may conduct fluid into or out of a bag. An upper sheet and a lower sheet of more flexible polymer are layered together and the access part is placed between the two sheets and at an edge thereof. The three parts are then sealed together, preferably by radio frequency, heat, or laser welding. This requires separate production of all three parts, manipulating the parts to keep them in alignment during sealing, as well as sealing parts with different material characteristics. Sealing the upper and lower sheets to the top and bottom of the access part is particularly difficult.

It is against this background that the instant invention was conceived.

### SUMMARY OF THE INVENTION

A disposable container for medical materials according to the present invention comprises a unitary sheet of biologically inert, flexible material, such as polyurethane or polyvinyl chloride (PVC). An access area is integrally molded in the sheet. At least one port in the access area allows fluids for medical uses to be introduced into the container.

In the disposable container, the unitary sheet is folded along the access area such that an upper part of sheet is adjacent a lower part of the sheet, and the upper part is attached to the lower part by radio frequency (RF) welding or adhesive to form a seal. One side of the sheet may be textured. Where the sides facing the interior of the container are textured, it is less likely that the upper and lower parts will stick together and thereby resist fluid entering the container. Various selected features may also be provided on the sheet, including a transparent window or raised features, such as bars or lines.

The method for making the disposable container includes forming a unitary sheet of biologically compatible flexible material having an access area integrally molded in the sheet and at least one port in the access area for allowing fluid biologic materials to be introduced into the container, folding the sheet along the access area such that an upper part of said sheet is adjacent a lower part of said sheet; and joining the upper part to the lower part. The method is preferably carried out by injection-molding of the upper and lower sheets and the access area as a single, unitary piece. This process is carried out using a distinctive mold. The mold has a central triangular prism and conforming upper and lower blocks. The access area is formed at an apex of the triangular prism. The upper part is formed between the prism and the conforming upper block, while the lower part is formed between the prism and the conforming lower block. After the container has been removed from the mold, the upper part is joined to the lower part only along the peripheral edges, but not along the access area. Radio frequency (RF) welding or another suitable method such as adhesive may be used to join the edges.

### BRIEF DESCRIPTION OF THE DRAWINGS

The accompanying drawings are included to provide a further understanding of the invention and are incorporated in and constitute a part of this specification. The drawings illustrate an embodiment of the invention and, together with the description, serve to explain the principles of the invention.

FIG. 1 is a plan view of a disposable set of bags for blood component separation.

FIG. 2 is a perspective view of a disposable injection-molded container for fluids for medical use according to the present invention, prior to final assembly.

FIG. 3 is a plan view of the container of FIG. 2.

FIG. 4 is a perspective view of a mold for making the container of FIG. 3.

FIG. 5 is a perspective view of a central part of the mold of FIG. 4.

FIG. 6 is a perspective view of an upper block from the mold of FIG. 4.

FIG. 7 is a perspective view of the central part shown in FIG. 5.

FIG. 8 is a perspective view of a lower block from the mold of FIG. 4.

FIG. 9 is a reverse view of the upper block of FIG. 6.

FIG. 10 is a perspective view of the central part of the mold with the container of FIG. 3 and an apparatus for removing the container from the central part of the mold.

FIG. 11 is another perspective view of the components of FIG. 10, showing vacuum features for removing the container.

### DESCRIPTION OF THE INVENTION

Reference will now be made in detail to the embodiments of the invention, examples of which are illustrated in the accompanying drawings. Wherever possible, the same reference numbers are used in the drawings and the description to refer to the same or like parts.

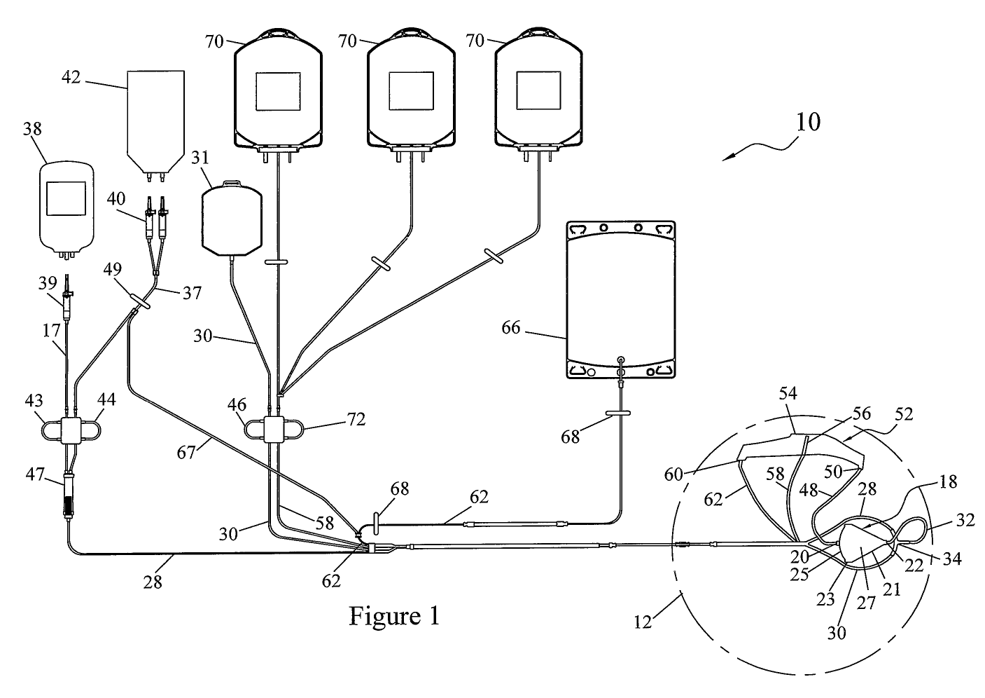

The present invention may be advantageously used in a variety of devices including, but not limited to, sample bags, medication bags, and bag sets for use with centrifuge devices commonly used to separate blood into its components. The set of bags for blood separation in a centrifuge device, such as an Elutra® blood component centrifuge manufactured by Gambro BCT, Inc. of Lakewood, Colo., as illustrated in FIG. 1, is only exemplary of the uses for the bags of the present invention.

FIG. 1 shows a set of bags comprising a disposable blood processing set including a particle separation disposable system 10 for use with a centrifuge rotor 12. Preferably, the centrifuge rotor 12 is coupled to a motor (not shown), so that the centrifuge rotor 12 rotates about its axis of rotation. A fluid chamber 18 is mounted on the rotor 12 such that an outlet 20 for components other than red blood cells, hereinafter called the outlet of the fluid chamber 18, is positioned closer to the axis of rotation than the inlet 22 of the fluid chamber 18. A holder (not shown) preferably orients the fluid chamber 18 on the rotor 12 with a longitudinal axis of the fluid chamber 18 in a plane transverse to the rotor's axis of rotation. In addition, the holder is preferably arranged to hold the fluid chamber 18 on the rotor 12 with the fluid chamber outlet 20 for components other than red blood cells facing the axis of rotation.

The fluid chamber 18 may be constructed similar to or identical to one of the fluid chambers disclosed in U.S. Pat. No. 5,674,173, or it may have smooth sides as shown. As shown in FIG. 1, the inlet 22 and outlet 20 of the fluid chamber 18 are arranged along a longitudinal axis of the fluid chamber 18. A wall 21 of the fluid chamber 18 extends between the inlet 22 and outlet 20 thereby defining inlet 22, the outlet 20, the side and an interior of the fluid chamber 18. The fluid chamber 18 includes two frustoconical shaped sections 25, 27 joined together at a maximum cross-sectional area 23 of the fluid chamber 18. The interior of the fluid chamber 18 tapers (decreases in cross-section) from the maximum cross-sectional area 23 in opposite directions toward the inlet 22 and the outlet 20. Although the fluid chamber 18 is depicted with two sections 25, 27 having frustoconical interior shapes, the interior of each section may be parabolic, or of any other shape having a major cross-sectional area greater than the inlet or outlet area.

As shown in FIG. 1, the disposable bag set 10 further includes a first conduit or line 28, second or debulk conduit or line 30 coupled to a debulk bag 31 through a tubing loop 46, which is mounted in a peristaltic pump (not shown), an inlet conduit or line 32 in fluid communication with the inlet 22 of the fluid chamber 18, and a three-way or Y connector 34 having three legs for flow or fluidly connecting the first conduit 28, second or debulk conduit 30, and inlet line 32. The first conduit 28 includes peristaltic pump loop 43 for flow-connecting the first conduit 28 with conduit or line 17, coupling 39 and a first source 38 containing fluid carrying particles to be separated from one another or the source blood product containing white blood cells. Likewise, the first conduit 28 is connected through pump loop 44 to conduit or line 37 which includes couplings 40 for flow-connecting the first conduit 28 with a second source 42 containing a low density diluting, sedimentation or elutriation fluid. The couplings 39 and 40 are preferably any type of common medical coupling devices, such as spikes or sterile tubing connectors. It is understood that lines or conduits 17 and 37 may be connected through a coupling (not shown) upstream of the inlet peristaltic pump loop so that a single loop pump (not shown) can be used.

As shown in FIG. 1, the first conduit 28 includes tubing loops 43 and 44. During use, the tubing loops 43 and 44 are mounted in a peristaltic pump (not shown) for respectively pumping the fluid or cell or particle product to be separated and the diluting, sedimentation or elutriation fluid from the first and second sources 38 and 42, respectively. The fluid and particles from the first source 38 and the diluting, sedimentation or elutriation fluid from the second source 42 flow through the respective first conduit 28 to the three-way connector 34. These substances then flow through the inlet line 32 into the inlet 22 of the fluid chamber 18. In the fluid chamber 18, which turns with rotor 12 when mounted thereon, the particles in the centrifugal field separate according to differences in sedimentation velocity leaving faster sedimenting particles in the fluid chamber 18 and allowing some slower sedimenting particles to flow from the fluid chamber 18 as will be described below.

As the fluid chamber 18 is loaded with particles, the fluid and particles having a relatively slower sedimentation velocity, which generally includes plasma, platelets, and possibly some white blood cells, flow through the fluid chamber outlet 20 into conduit tubing or line 48. As shown in FIG. 1, the tubing 48 is connected to an inlet 50 of separation vessel 52 or particle concentrator mounted on the centrifuge rotor 12. As described below, the separation vessel 52 or concentrator concentrates particles from fluid. Also during any elutriation process to separate the white blood cells into subsets such separated subsets will flow from the fluid chamber 18 to the separation vessel 52 or concentrator.

Adjacent to an outer portion of the centrifuge rotor 12, the separation vessel 52 or concentrator has a collection well 54 for collecting particles flowing into the separation vessel 52 or concentrator. Rotation of centrifuge rotor 12 sediments particles into the collection well 54 while slower sedimenting fluid and possibly some slower sedimenting particles remain above a top boundary of the collection well 54. The collected particles in the collection well 54 can include any cells or particles that have exited the fluid chamber 18, including a separated subset of white blood cells.

The collection well 54 has a particle concentrate outlet 56 connected to a particle concentrate line or conduit 58. The particle concentrate line 58 removes particles retained in the collection well 54 along with a small portion of fluid. The separation vessel 52 also includes a fluid outlet 60 connected to a fluid outlet line or conduit 62. The fluid outlet line 62 removes fluid flowing above a top boundary of the collection well 54. This fluid may include plasma or elutriation buffer or low density fluid. In addition, the fluid outlet line 62 may remove some slower sedimenting particles flowing above the top boundary layer past the collection well 54.

Preferably, fluid outlet 60 is located at or adjacent to one end of the separation vessel 52 or concentrator, and the inlet 50 is located at or adjacent to an opposite end of the separation vessel 52 or concentrator. This spacing ensures ample time for separation of particles from fluid, collection of a substantial number of particles in the collection well 54, and corresponding removal of a substantial number of particles including any separated subsets of white blood cells through the particle concentrate line 58.

The fluid outlet line 62 is fluidly coupled to a fluid collection container 66 for optionally collecting part of the fluid removed from the separation vessel 52 or concentrator, and the particle concentrate line 58 is fluidly coupled to one or more particle collection containers 70 for collecting particles removed from the separation vessel 52 or concentrator. Preferably, the particle concentrate line 58 includes a tubing loop or outlet pump loop 72 capable of being mounted in a peristaltic pump for pumping particles through the particle concentrate line 58. The pump for tubing loop 72 regulates the flow rate and concentration of particles in particle concentrate line 58. The white blood cells of interest or desired particles will be collected into one of the bags 70. It is understood that any number of bags 70 can be used to collect the desired subsets of white blood cells.

Fluid and particles from the first source 38 are connectable by conduit 17 and tubing loop 43 associated with a peristaltic pump to air chamber 47. Also diluting, sedimentation or elutriation fluids from source 42 are connectable by conduit 37 and tubing loop 44 associated with a peristaltic pump to air chamber 47. Air chamber 47 provides an inlet filter for filtering aggregates prior to particle separation. Also the air chamber 47 acts as a bubble trap and an air detection chamber. The air chamber 47 further functions as a fluid pulse suppressor. A recirculation line or conduit 67 is connected from line or conduit 62 to fluid inlet line or conduit 37. A slide clamp or other flow controlling element 49 is on conduit 37 and a slide clamp or other flow controlling element 68 is on line 62. Substantially cell-free and plasma-free media or fluid can be directed through line 67 to upstream of inlet pump loop 44. This allows diluting buffer or media to be re-circulated and used as will be further described. The initial media or fluid from the concentrator 52 may contain plasma or cells undesirable for recirculation. This initial media or fluid is directed to waste bag 66, as described below, prior to initiation of the recirculation process.

The forgoing description of a disposable blood collection bag set is offered as an example only. Clearly both single bags and sets of bags, as described above, may employ the injection-molded bags of the present invention wherever bags constructed by conventional methods have been used or in which such bags may be used.

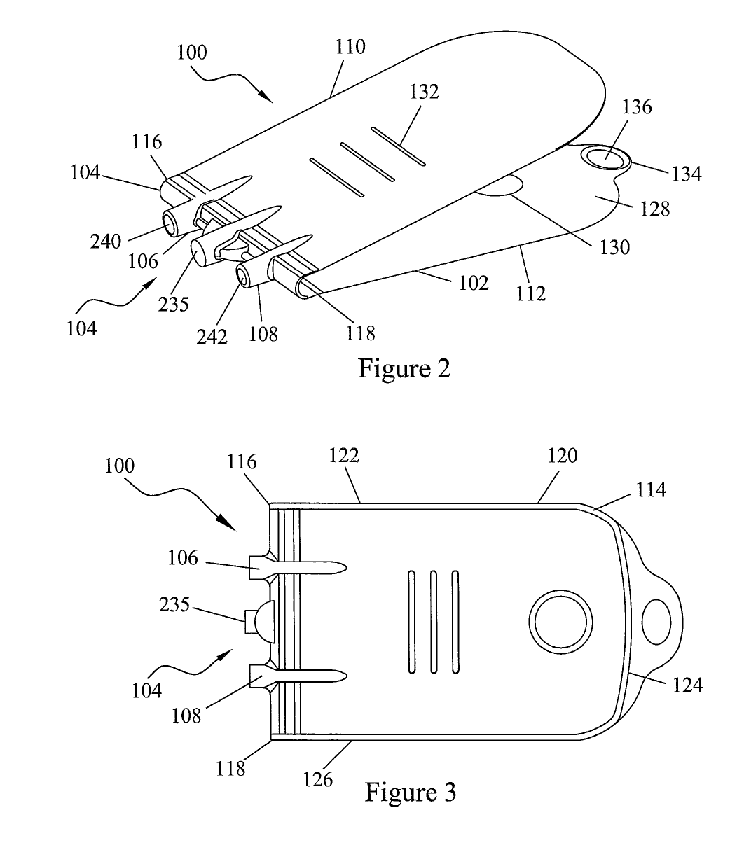

FIG. 2 illustrates a disposable container 100 for fluids or other materials for medical use according to the present invention, the container comprising a unitary sheet 102 of flexible material, such as polyurethane or polyvinyl chloride (PVC). An access area 104 is integrally molded in the sheet 102. At least one port 106, 108 in the access area allows fluid biologic materials to be introduced into the container 100. Heretofore, medical fluid bags or containers have been made of three or more parts, such as an upper sheet, a lower sheet and a separate port. All three parts (or more, if additional ports were to be provided) had to be held in accurate position with respect to each other when the parts were welded together. Moreover, the ports were often formed of different, more rigid material than the sheets. A weld would have been necessary on both the top and the bottom of the ports to join the upper and lower sheets to the port. If more than one port were provided, the upper and lower sheets would have to be welded to each other between the ports. These complications are eliminated by use of the apparatus and method described herein.

In the disposable container 100, the unitary sheet 102 is folded along the access area such that an upper part 110 of sheet is adjacent a lower part 112 of the sheet, and the upper part 110 is attached to the lower part 112 in any suitable fashion, as by RF welding or adhesive, to form a seal 114 (see FIG. 3). The seal 114 extends from a first end 116 of the access area 104 to a second end 118 of the access area 104. Consequently, the disposable container comprises at least two edges, and the access area being a first edge and the seal being a second edge 120. The seal 114 may also be considered to form three (or more) edges, such as a left side 122, a back 124 and a right side 126, each of these sides or edges being adjacent each other.

The disposable container 100 therefore comprises a unitary injection-molded part, with the access area 104 being centrally located between the upper part 110 and the lower part 112 of the sheet 102, the upper part having a first peripheral edge extending from the first end 116 of the access area 104 to the second end 118 of the access area and the lower part 112 having a second peripheral edge extending from the first end 116 of the access area 104 to the second end 118 of the access area 104. The first peripheral edge is sealed to said second peripheral edge in any suitable manner, for example by RF welding or by an adhesive. The seal joins the upper part to the lower part along the peripheral edges, but not along the access area.

In a preferred embodiment, at least one side of the sheet is textured 128. Where the sides facing the interior of the container are textured 128, it is less likely that the upper and lower parts will stick together and thereby resist fluid entering the container. Various selected features may also be provided on the sheet, by appropriate formation of a mold for injection-forming of the container, as described further hereafter. Such surface features may include, but are not limited to a molded surface treatment forming a transparent window 130 or raised features 132, such as bars or lines. The lower part 112 of the sheet may also have an extension 134 outside the seal 114, with a hole 136 or slot for supporting the container on a bracket or stand, as is known in the art.

The method for making the disposable container for biologic materials will now be described. The method includes forming a unitary sheet of biologically compatible flexible material having an access area integrally molded in the sheet and at least one port in the access area for allowing fluid biologic materials to be introduced into the container, folding the sheet along the access area such that an upper part of said sheet is adjacent a lower part of said sheet; and joining the upper part to the lower part. The method is preferably carried out by injection-molding of the upper and lower sheets and the access area as a single, unitary piece. This process is carried out using a distinctive mold. The mold has a central triangular prism and conforming upper and lower blocks. The access area is formed at an apex of the triangular prism. The upper part is formed between the prism and the conforming upper block, while the lower part is formed between the prism and the conforming lower block. Surfaces of the upper and lower blocks or the prism may be textured to provide selected surface characteristics to the surfaces of the container. The surfaces textures may include roughened surfaces, which do not stick together as easily as smooth surfaces and which therefore allow fluid to enter the container, polished areas for optical inspection ports, or raised surface features such as lines. The mold that enables these features will be described in greater detail hereafter. One skilled in injection molding will recognize that such a mold may be utilized in commercially available injection presses, such as a Synergy 1000™ press available from Netstal-Machinen AG. The functionality of injection-molding presses is well known and need not be further described herein.

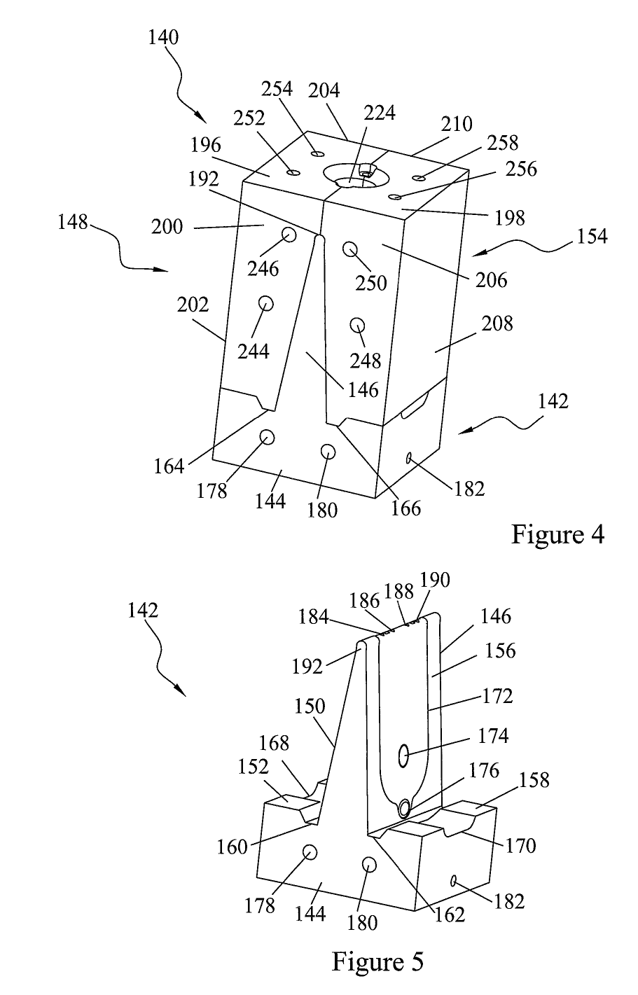

As shown in FIG. 4 and FIG. 5, the mold 140 comprises three interlocking parts. A central part 142 (see FIG. 5) has a base 144 and a central, symmetrically mounted, triangular prism 146. Triangular prism means a solid formed by extending a generally triangular figure lying in an x-y plane in a z-direction. An upper block 148 (see FIG. 4) conforms to an upper planar side 150 of the triangular prism 146 and to a first upper surface 152 of the base 144. Similarly, a lower block 154 conforms to a lower planar side 156 of the triangular prism 146 and to a second upper surface 158 of the base 144. When the central part 142 is assembled with the upper and lower blocks 148, 154, a rectangular prism is formed, as shown in FIG. 4, suitable for use in a commercial injection press. Ridges 164, 166 on the upper and lower blocks 148, 154 fit into grooves 160, 162 at the junctions between the upper planar side 150 and the first upper surface 152 and between the lower planar side 156 and the second upper surface 158. This interlocks the three pieces and resists movement during the injection molding process.

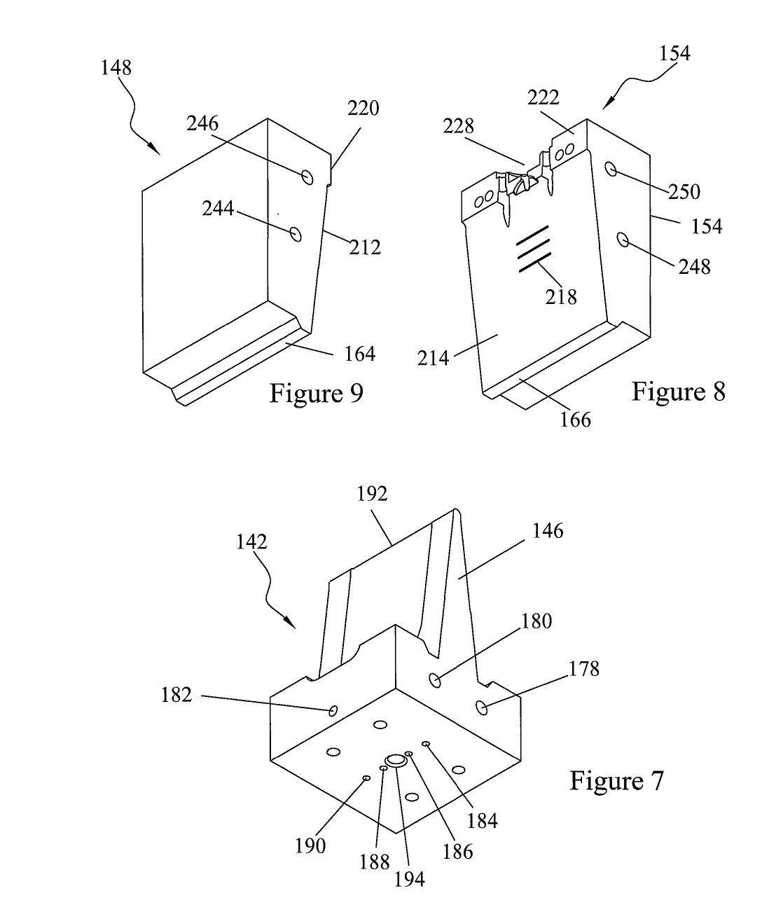

The central part 142 also has slots 168, 170 in the upper surfaces 152, 158 of the base. The slots aid in disassembling the mold 140 after a container has been molded in it. A recessed pattern 172 on the planar sides 150, 156 of the triangular prism 146 has the shape of the desired container and defines the volume into which polymer will be injected. The surface of the recessed pattern may be given any suitable texture. For example, a roughened texture would reduce the likelihood that the sides of the molded container would stick together, a condition that would resist fluids entering the finished container. A polished area 174 might also have an optical window in the completed container. A protuberance 176 may form a tab or extension for hanging the container, as described above. Water or another heat-transfer fluid may flow through channels 178, 180, 182 in the central part 142 to rapidly reduce the temperature of the mold and solidify the elastomeric material being formed into a container. Through bores 184, 186, 188, 190 extend from the base 144 to an apex 192 of the triangular prism 146. Rods (not shown) slide through the bores 184, 186, 188, 190 to free the injection molded part from the mold. A threaded bore 194 (see FIG. 7) may be provided for mounting the central part in the commercial injection molding press.

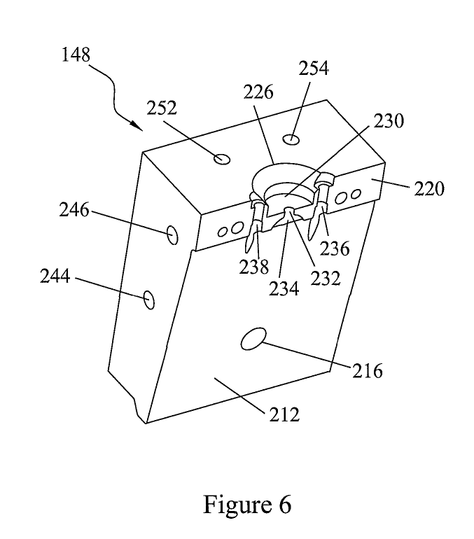

The upper block 148 and the lower block 154 are substantially symmetrical and fit against the central part 142 to create the mold. Each block 148, 154 comprises an upper surface 196, 198 and three outer sides 200, 202, 204 and 206, 208, 210, respectively, all of which meet at right angles. Together with the base 144 of the central part 142, the blocks form a rectangular prism that can be mounted in the injection molding press. As shown in FIG. 7, FIG. 8 and FIG. 9, each block also has a planar molding surface 212, 214, which are congruent with the planar sides 150, 156 of the triangular prism 146 (see FIG. 5). The molding surfaces 212, 214 may be given a selected surface finish, textured or smooth, as desired. In particular, special features such as a polished window area 216 (FIG. 6) or raised patterns 218 (FIG. 8), such as parallel lines, may be provided.

The upper and lower blocks 148, 154 abut each other at mold surfaces 220, 222, respectively, adjacent the apex 192 of the triangular prism 146. When the blocks are assembled, an orifice 224 is formed by symmetrical channels 226, 228. The injection molding press forces plastic material through the orifice 224 and into the mold. In addition, the ports 106, 108 are formed in features in the channels. As seen in FIG. 6, a channel, such as channel 226, comprises a central exterior chamber 230 that couples with a nipple (not shown) of the injection molding press whereby the press injects plastic into the mold. The biocompatible plastic or polymer passes through a neck 232 and into a nozzle 234 to begin spreading through the mold. A solid stem 235 (FIG. 2) is formed as an artifact of this process where the polymer is injected into the mold. Polymer may also flow from the chamber 230 into port channels 236, 238, which create the ports 106, 108. Rods (not shown) may be positioned within the port channels 236, 238 to form lumens 240, 242. Tubes (see FIG. 1) may be connected to the ports to allow fluid to flow through the lumens and into and out of the completed container. As with the central part 142, the blocks 148, 154 have channels 244, 246, 248, 250 (FIG. 8 and FIG. 9) through which water or a suitable heat transfer fluid may flow to cool the blocks and the part being created within the mold. Bores 252, 254, 256, 258 may also be provided for mechanically coupling the blocks 148, 154 to the injection molding press, according to the specifications for the particular commercially available press selected.

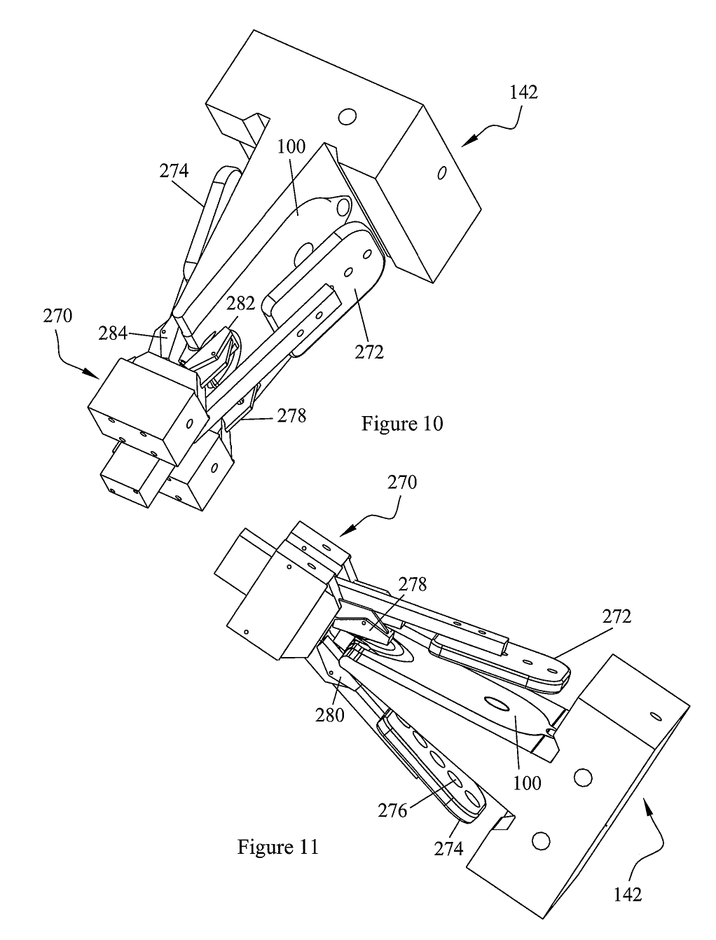

To manufacture the disposable container for biologic materials the mold 140 is placed in an injection molding press. Suitable bio-compatible polymer is injected through the orifice 224, forming a unitary sheet of biologically compatible flexible material, the sheet having an upper part and a lower part, the upper part having a first peripheral edge and the lower part having a second peripheral edge, and further forming an access area integrally molded in the sheet adjacent the apex 192 of the triangular prism 146. The access area has at least one port in the access area for allowing fluid biologic materials to be introduced into the container. After the mold and polymer have been cooled, allowing the polymer to solidify, the mold is disassembled, exposing the polymeric part on the triangular prism. The part is removed by thrusting the access area away from the apex of the triangular prism, using, for example, rods inserted through the bores 184, 186, 188, 190 (FIG. 7) and by lifting the upper part of the container away from the triangular prism, and lifting the lower part of the container away from the triangular prism. As shown in FIG. 10 and FIG. 11, a manipulator 270 may be provided with opposing vacuum paddles 272, 274. Pneumatic suction through openings 276 in the paddles permits the upper and lower parts of the container to be lifted away from the triangular prism. Clamps 278, 280 and 282, 284 with conforming faces can simultaneously fit over the ports 106, 108, allowing the ports to be pulled away from the apex of the triangular prism without distortion.

After the container has been removed from the mold, the upper part is joined to the lower part only along the peripheral edges, but not along the access area. Laser welding or another suitable method such as adhesive may be used to join the edges.

The structure and method of assembly of the container reduces the number of parts and simplifies assembly of the containers, resulting in increased reliability, reduction in cost, and other advantages.

It will be apparent to those skilled in the art that various modifications and variations can be made to the structure and methodology of the present invention without departing from the scope or spirit of the invention. In view of the foregoing, it is intended that the present invention cover modifications and variations of this invention provided they fall within the scope of the following claims and their equivalents.

What is claimed is:

1. A disposable container for biologic materials comprising
a unitary sheet of biologically compatible flexible material,
an access area integrally molded in said sheet,
at least one port in said access area for allowing fluid biologic materials to be introduced into said container,
said sheet being folded along said access area such that an upper part of said sheet is adjacent a lower part of said sheet; and
a seal joining said upper part to said lower part.

2. The disposable container of claim 1 wherein said seal extends from a first end of said access area to a second end of said access area.

3. The disposable container of claim 2 wherein said container comprises at least two edges, and said access area comprises a first edge and said seal comprises a second edge.

4. The disposable container of claim 3 wherein said container has at least four edges and said seal further comprises a third edge and a fourth edge, said second, third and fourth edges being adjacent each other.

5. The disposable container of claim of claim 1 wherein said container comprises a unitary injection-molded part, said access area being centrally located between said upper part and said lower part of said sheet, said upper part having a first peripheral edge extending from a first end of said access area to a second end of said access area and said lower part having a second peripheral edge extending from said first end of said access area to said second end of said access area.

6. The disposable container of claim 5 wherein said first peripheral edge is sealed to said second peripheral edge.

7. The disposable container of claim 1 wherein at least one side of said sheet is textured.

8. The disposable container of claim 7 wherein a first side of at least one of said upper and said lower parts of said sheet is textured, said first side facing an interior of said container.

9. The disposable container of claim 8 wherein the sides facing the interior of said container of both upper and lower parts are textured.

10. The disposable container of claim 1 wherein said sheet further comprises a molded surface treatment.

11. The disposable container of claim 1 wherein said lower part of said sheet further comprises an extension outside said seal, said extension having means for supporting said container.

12. A disposable container for biologic materials comprising
a unitary sheet of biologically compatible flexible material, said sheet having an upper part and a lower part;
said upper part having a first peripheral edge and said lower part having a second peripheral edge
an access area integrally molded in said sheet,
at least one port in said access area for allowing fluid biologic materials to be introduced into said container, and
a seal joining said upper part to said lower part along said peripheral edges, but not along said access area.

13. The disposable container of claim 12 wherein a first side of at least one of said upper and said lower parts of said sheet is textured, said first side facing an interior of said container.

14. The disposable container of claim 13 wherein the sides facing the interior of said container of both upper and lower parts are textured.

15. The disposable container of claim 12 wherein said sheet further comprises a molded surface treatment.

16. A method for making a disposable container for biologic materials comprising
forming a unitary sheet of biologically compatible flexible material having an access area integrally molded in said sheet and at least one port in said access area for allowing fluid biologic materials to be introduced into said container,
folding said sheet being folded along said access area such that an upper part of said sheet is adjacent a lower part of said sheet; and
joining said upper part to said lower part.

17. The method of claim 16 wherein said seal extends from a first end of said access area to a second end of said access area.

18. The method of claim of claim 16 wherein said forming step comprises injection-molding a unitary part, said access area being centrally located between said upper part and said lower part of said sheet, said upper part having a first peripheral edge extending from a first end of said access area to a second end of said access area and said lower part having a second peripheral edge extending from said first end of said access area to said second end of said access area.

19. The method of claim 18 further comprising sealing said first peripheral edge to said second peripheral edge.

20. The method of claim 18 further comprising
providing a mold having a central triangular prism and conforming upper and lower blocks,
forming said access area at an apex of said triangular prism,
forming said upper part between said prism and said conforming upper block, and
forming said lower part between said prism and said conforming lower block.

21. The method of claim 20 further comprising texturing at least one interior side of said mold.

22. The method of claim 20 further comprising texturing at least one side of said triangular prism.

23. The method of claim 20 further comprising
opening said mold;
lifting said upper part of said container away from said triangular prism;
lifting said lower part of said container away from said triangular prism; and
pushing said access area away from the apex of said triangular prism.

24. The method of claim 18 further comprising providing an extension outside said seal on said lower part of said sheet, said extension having means for supporting said container.

25. A method for making disposable container for biologic materials comprising
forming by injection molding a unitary sheet of biologically compatible flexible material, said sheet having
an upper part and a lower part, said upper part having a first peripheral edge and said lower part having a second peripheral edge, and
an access area integrally molded in said sheet with at least one port in said access area for allowing fluid biologic materials to be introduced into said container, and
joining said upper part to said lower part only along said peripheral edges, but not along said access area.
